(19) United States
(12) Patent Application Publication
(10) Pub. No.: US 2020/0145687 A1
(43) Pub. Date: May 7, 2020

(54) USING HEADSET MOVEMENT FOR COMPRESSION

(71) Applicant: DisplayLink (UK) Limited, Cambridge - Cambridgeshire (GB)

(72) Inventor: Ian Doidge, Cambridge - Cambridgeshire (GB)

(21) Appl. No.: 16/617,045

(22) PCT Filed: Jun. 8, 2018
(86) PCT No.: PCT/GB2018/051567

§ 371 Date: Nov. 26, 2019

(30) Foreign Application Priority Data
Jun. 9, 2017 (GB) 1709237.0

(51) Int. Cl. H04N 19/51; G06F 3/01; H04N 13/344

(52) U.S. Cl. CPC H04N 19/51; H04N 13/344; G06F 3/012

(57) ABSTRACT

A method at a host device (11) for compressing display data forming an image for display on one or more displays (19) of a wearable headset (12), such as a virtual or augmented reality headset. The method involves receiving from the wearable headset (12), information regarding movement of the wearable headset (12). If the movement is sufficient, all or some of the display data is compressed. The compressed data may form a trailing portion of the image relative to a leading portion as the headset (12) moves on an arc and may be of any size smaller than the whole image and may change in size on a frame to frame basis. The display data forming the image is then forwarded from the host device (11) to the wearable headset (12) for display on the one or more displays (19).

### BACKGROUND

Virtual reality is becoming an increasingly popular display method, especially for computer gaming but also in other applications. This introduces new problems in the generation and display of image data as virtual reality devices must have extremely fast and high-resolution displays to create an illusion of reality. This means that a very large volume of data must be transmitted to the device from any connected host.

As virtual-reality display devices become more popular, it is also becoming desirable for them to be wirelessly connected to their hosts. This introduces considerable problems with the transmission of the large volume of display data required, as wireless connections commonly have very limited bandwidth. It is therefore desirable for as much compression to be applied to the display data as possible without affecting its quality, as reductions in quality are likely to be noticed by a user.

Finally, it is desirable for virtual-reality devices to be as lightweight as possible, since they are commonly mounted on the user's head. This limits the number of internal devices such as complex decompression circuits and sensors that can be provided.

The invention aims to mitigate some of these problems.

### SUMMARY

Accordingly, in one aspect, the invention provides a method at a host device for compressing display data forming an image for display on one or more displays of a wearable headset, the method comprising:

receiving from the wearable headset, information regarding a direction of movement of the wearable headset, including the one or more displays, the direction being between a trailing position and a leading position;

if the direction of the movement is on an arc, compressing the display data forming a trailing portion of the image relative to the display data forming a leading portion of the image, when displayed on the one or more displays that are moving with the wearable headset, wherein the leading portion and the trailing portion may be of any size smaller than the whole image and may change in size on a frame to frame basis; and

forwarding the display data forming the image from the host device to the wearable headset for display on the one or more displays thereof.

In one embodiment, the information further comprises a speed of the movement and compression of the display data forming at least the trailing portion of the image is performed if a speed of the movement is above a minimum threshold. Compression of the display data forming the whole of the image is preferably performed if a speed of the movement is above a minimum threshold. The compression of the display data forming a part of, or the whole of the image may be based on the speed of the movement above the minimum threshold. The compression of the display data forming a part of, or the whole of the image may be increased as the speed of the movement above the minimum threshold increases.

According to a second aspect, the invention provides a method at a host device for compressing display data forming an image for display on one or more displays of a wearable headset, the method comprising:

receiving from the wearable headset information regarding a speed of movement of the wearable headset, including the one or more displays;

if the speed of the movement is above a minimum threshold, compressing the display data by an amount based on the speed of the movement above the minimum threshold; and

forwarding the compressed display data from the host device to the wearable headset for display thereon.

In an embodiment, the compression of the display data forming the image may be increased as the speed of the movement above the minimum threshold increases.

Preferably, the information further comprises a direction of movement of the wearable headset, including the one or more displays, the direction being between a trailing position and a leading position, the method further comprises, if the direction of the movement is on an arc, compressing the display data forming a trailing portion of the image relative to the display data forming a leading portion of the image, when displayed on the one or more displays that are moving with the wearable headset.

In a preferred embodiment, the display data forming a trailing portion of the image is compressed by a higher compression factor than the display data forming a leading portion of the image. Preferably, compression of the display data is increased in portions across the image in the direction from the leading portion to the trailing portion of the image. The trailing portion may, in some cases, increase in size compared to the leading portion of the image as the speed of the movement above the minimum threshold increases.

In embodiment, the method comprises, at the host device:

determining, from the information, whether the movement is on an arc or linear;

determining, from the information, the speed of the movement of the wearable headset;

and

determining whether the speed of the movement is above the minimum threshold.

In another embodiment, the method comprises, at the wearable headset:

determining whether the movement of the wearable headset is on an arc or linear;

determining the speed of the movement of the wearable headset;

determining whether the speed of the movement is above the minimum threshold; and

sending the information to the host device, if the movement is on an arc and the speed is above the minimum threshold.

According to a third aspect, the invention provides a method at a wearable headset for displaying display data forming an image on one or more displays, the method comprising:

sensing movement of the wearable headset indicative of movement of the one or more displays;

determining whether the movement is on an arc or linear;

determining the speed of the movement of the wearable headset;

determining whether the speed of the movement is above a minimum threshold;

sending information regarding the speed and direction of the movement to a host device, if the movement is on an arc and the speed is above the minimum threshold;

receiving from the host device, the display data forming the image; and

displaying the image on one or more displays.

Preferably, sensing movement of the wearable headset comprises using a gyroscope and an accelerometer in the wearable headset.

In a further aspect, the invention may provide a host device and a wearable headset configured to perform the various appropriate steps of the method described above.

The wearable headset may be a virtual reality headset or an augmented reality set of glasses.

A system comprising a host device and a wearable headset connected to the host device may also be provided.

In another aspect, the invention provides a method of applying adaptive compression to display data according to sensor data indicating that a headset is in motion, the method comprising:

Detecting a movement of the headset

Analysing the movement to determine its direction and/or speed

Applying compression selectively to display data according to the results of the analysis

Transmitting the display data for display Decompressing and displaying the display data

The analysis may comprise determining the direction of the movement only and applying localised compression, in which the part of an image assumed to be moving out of the user's vision based on this movement is compressed to a greater degree than the remainder of the image. Alternatively or additionally, the analysis may comprise determining the speed of the movement and applying staged compression, in which compression is applied to a greater extent across the whole frame as the speed of the movement increases.

This above described methods are advantageous as they allows assumptions regarding user gaze to be used to improve compression without requiring additional sensors to be incorporated into a device. This provides compression benefits without increasing the expense and complexity of such devices.

### BRIEF DESCRIPTION OF THE DRAWINGS

Embodiments of the invention will now be more fully described, by way of example, with reference to the drawings, of which:

FIG. 1 shows a basic overview of the system according to one embodiment of the invention;

FIG. 2 shows a more detailed block diagram of a VR headset in use;

FIG. 3 shows the application of localised compression;

FIG. 4 shows a variation on localised compression;

FIG. 5 shows a further variation on localised compression;

FIG. 6 shows the application of staged compression;

FIG. 7 shows the process of the application of localised compression;

FIG. 8 shows the process of the application of staged compression;

FIG. 9 shows the application of adaptive compression; and

FIG. 10 shows the process of the application of adaptive compression;

### DETAILED DESCRIPTION OF THE DRAWINGS

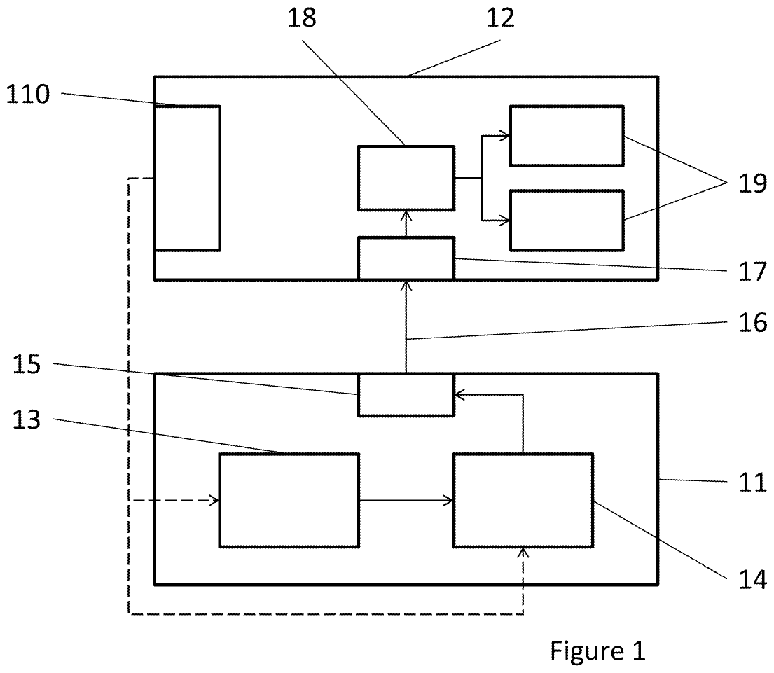

FIG. 1 is a block diagram showing a basic overview of a display system arranged according to the invention. In this system, a host [11] is connected by connection [16] to a virtual-reality headset [12]. This connection [16] may be wired or wireless, and there may be multiple connection channels, or there may be a single bidirectional connection which is used for multiple purposes. For the purposes of this description, the connection [16] is assumed to be a general-purpose wireless connection, such as one using the Universal Serial Bus (USB) protocol, although other appropriate protocols could, of course, be used.

The host [11] incorporates, among other components, a processor [13] running an application which generates frames of display data using a graphics processing unit (GPU) on the host [11]. These frames are then transmitted to a compression engine [14], which carries out compression on the display data to reduce its volume prior to transmission. The transmission itself is carried out by an output engine [15], which controls the connection to the headset [12] and may include display and wireless driver software.

The headset [12] incorporates an input engine [17] for receiving the transmitted display data, which also controls the connection [16] to the host [11] as appropriate. The input engine [17] is connected to a decompression engine [18], which decompresses the received display data as appropriate. The decompression engine [18] is in turn connected to two display panels [19], one of which is presented to each of a user's eyes when the headset [12] is in use. When the display data has been decompressed, it is transmitted to the display panels [19] for display, possibly via frame or flow buffers to account for any unevenness in the rate of decompression.

The headset [12] also incorporates sensors [110] which detect user interaction with the headset [12]. There may be a variety of position, temperature, heartbeat, angle, etc. sensors [110], but the important sensors [110] for the purposes of this example are sensors used to detect the movement of the headset [12]. In this example, these comprise an accelerometer for determining the speed at which the headset [12] is moving, and a gyroscope for detecting changes in its angle and position in space. However, other methods can be used, such as an external camera which determines headset movement by detecting the movement of points of interest in the surroundings, or a wireless module that may be able to derive movement from a beamforming signal. In any case, the sensors [110] are connected to the host [11] and transmit data back to it to control the operation of applications on the host [11].

Specifically, the sensors [110] provide information to the processor [13], since the output of the sensors [110] will affect the display data being generated. For example, when the user moves the display data shown to him or her must change to match that movement to create the illusion of a virtual world. The sensor data, or a derivative of the sensed data, is also sent to the compression engine [14] according to embodiments of the invention.

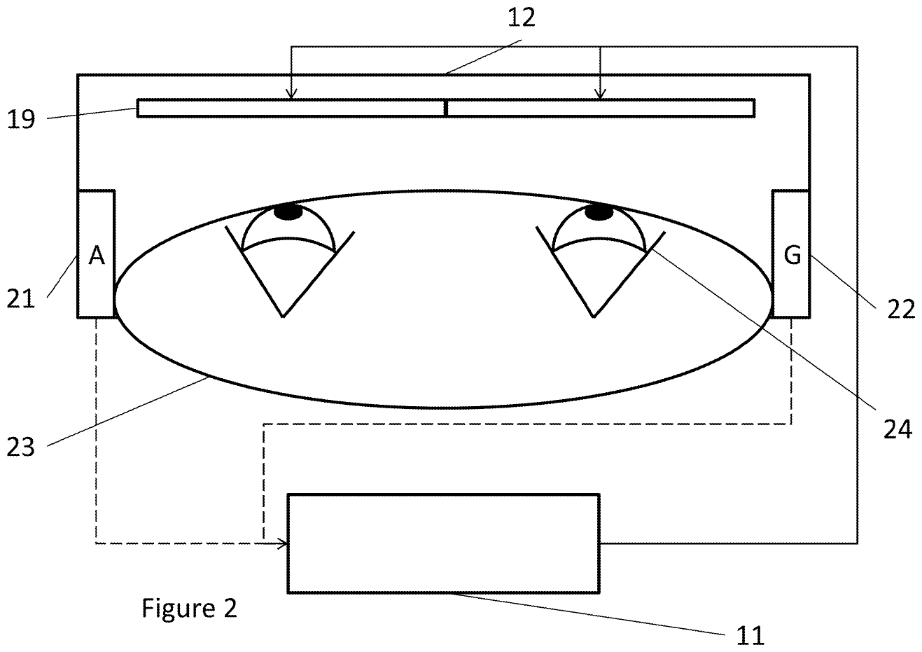

FIG. 2 shows a view of the headset [12] of FIG. 1 when it is in use. For simplicity, the internal workings of the host [11] and the input [17] and decompression [18] engines on the headset [12] are not shown.

As previously mentioned, the headset [11] incorporates two display panels [19], each presented to one of the eyes [24] of a user [23], when in use. These two panels may in fact be a single display panel which shows two images, but this will not affect the operation of these embodiments of the invention.

In FIG. 2, the accelerometer [21] and gyroscope [22] are separately shown. Since they are incorporated in the VR headset [12] mounted on the head of the user [23] when the system is in use, they will detect all movements of the head of the user [23]. Naturally, if the headset [12] is moved when not being worn, the sensors [21, 22] will also detect this movement, though optionally an additional sensor in the headset [12] could be used to switch various functions on and off depending on whether the headset [12] is being worn. This could be useful if, for example, the image data is also being transmitted to an external display for demonstration purposes.

In any case, the sensors [21, 22] transmit sensor data to the host [11] as previously described, and the host [11] transmits image data for display on the display panels [19] as previously described.

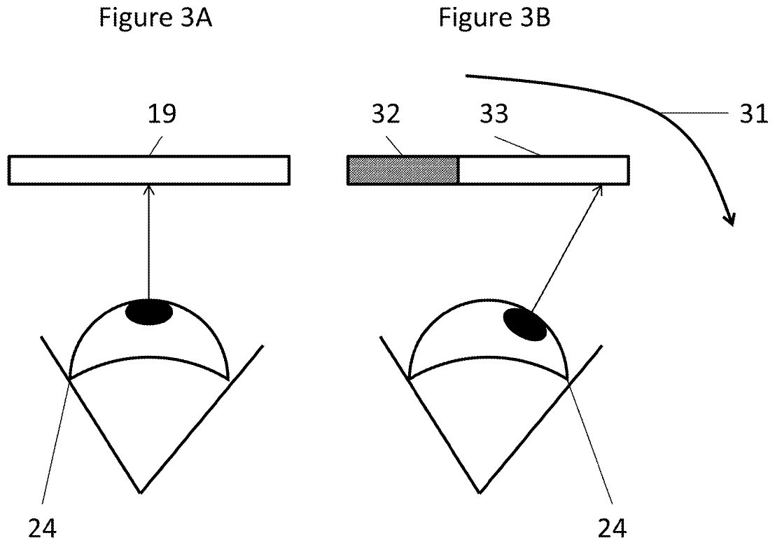

FIG. 3 shows an example of the use of localised compression to reduce the amount of data that needs to be transmitted to the headset. When the headset [12] is not in motion, as in FIG. 3A, the user [23] is assumed to be looking at the centre of the display panel [19] as shown by the direction of the arrow pointing from the eye [24] to the panel [19]. Naturally, the user may look at other locations on the display panel [19], but in the absence of eye-tracking this cannot be ascertained. Therefore, the data for all parts of the display panel [19] should be provided in a uniform fashion. This may mean that no compression is applied or that a lossless or low-loss compression algorithm is applied.

FIG. 3B shows the case where the headset [12] is in motion, as where the user [23] turns his or her head. The curved arrow [31] shows the direction of motion: in an arc to the right. It is assumed that when the user [23] is turning his or her head to the right, he or she is looking to the right: this is shown in the Figure by the movement of the eye [24] and the arrow pointing from the eye [24] to the display panel [19] and indicating the direction of gaze. Since there is no eye-tracking, this cannot be guaranteed, but based on normal human behaviour—in which the user [23] would turn his or her head because he or she wished to view something to the right—it can be assumed.

Accordingly, localised relative compression is applied to the left part of the image shown on the display panel [19]. This is shown by the hatched area [32] on the panel shown in the Figure: since the user is looking to the right, the left-hand side of the image—i.e. the trailing side relative to the direction of the movement—will be in the user's peripheral vision, where the human eye has low acuity. He or she will therefore not be aware of any loss of quality if that part of the image is compressed more than the right-hand side [33] at which the user is assumed to be actually looking.

This compression could be applied whenever there is movement, or only after the speed of movement is above a minimum threshold. The speed of the movement could also be used to determine the level of compression used, such that as the speed of the movement increases an increased level of compression is used on the same area [32].

This allows higher levels of compression to be applied to the trailing part of the frame as compared to the leading part of the frame. Thus, either compression is applied to the trailing area whereas it was not used before, or a compression algorithm that allows greater loss of data may be used.

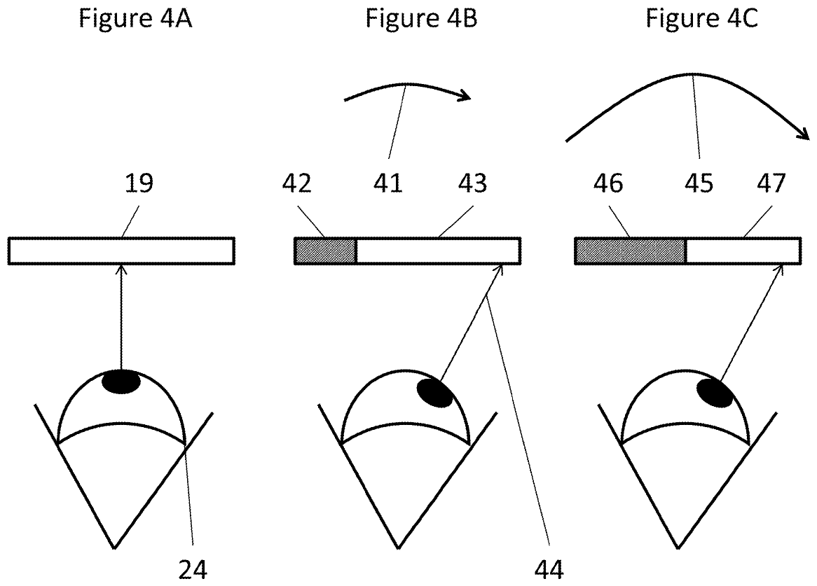

FIG. 4 shows a variation of localised relative compression. As described in FIG. 3, when the headset [12] is not in motion, as in FIG. 4A, a uniform level of compression (or no compression) is applied to the display data across the whole of the display panel [19]. Where the headset [12] is in motion, as in FIGS. 4B and 4C, compression is applied on the trailing side [42/46] of the display panel [19].

FIG. 4B shows the case where the headset [12] is moving slowly, as indicated by the relatively short arrow indicating the movement [41]. As previously described in FIG. 3, a smaller area [42] on the trailing side of the image is compressed to a higher level than the rest of the image [43], since the system assumes that the user [23] will be looking in the direction of movement, as indicated by the arrow [44] representing the user's gaze. The application of compression to this smaller area [42] may be triggered by the speed of the movement exceeding a first threshold.

FIG. 4C shows the case where the headset [12] is moving more quickly, as indicated by the longer arrow [45] representing the movement. In this case, the speed of the movement has exceeded a second threshold and therefore a larger area [46] on the trailing side of the image is compressed to a higher level than the rest of the image [47]. In this example, the same level of compression is used for the larger area [46] shown in FIG. 4C as was used for the smaller area [42] shown in FIG. 4B, but a different level of compression could be applied at higher speeds as well as the size of the compressed area [42/46] being increased.

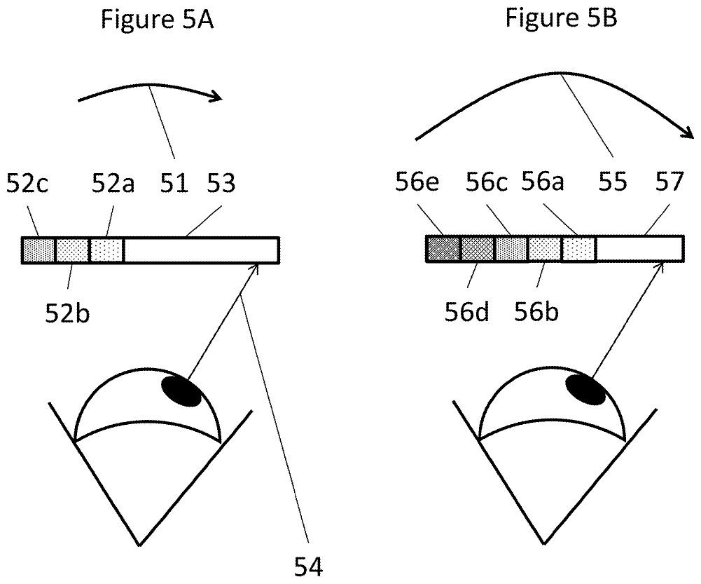

FIG. 5 shows a further variation on localised relative compression, whereby different levels of compression are applied in discrete steps or even in a continuum across the image when the headset [12] is in motion.

FIG. 5A shows a case where the headset [12] is moving relatively slowly, as indicated by the relatively short arrow [51] representing the movement. An area on the trailing portion [52] of the image is compressed when the speed of the motion is above a minimum threshold, which may simply mean that the headset [12] is moving at all. However, rather than the whole area of the trailing portion [52] being compressed to the same level as in the embodiments of FIGS. 3 and 4, the level of compression is increased in steps across the trailing portion [52] of the image from the leading portion [53] to the trailing edge, so that, for example area 52c is compressed more than area 52b, which in turn is compressed more than area 52a.

This method may be used in a similar way to the localised relative compression described in FIG. 3, whereby the trailing portion [52] is always the same size, or the trailing portion [52/56] may change in size as in the variation shown in FIG. 4. This may mean changing the sizes of the differently-compressed areas [52a, b, c], or it may mean adding more gradations of compression as described below with reference to FIG. 5B.

FIG. 5B shows a case where the headset [12] is moving more quickly, as indicated by the longer arrow [55] representing the movement. A larger area of the trailing portion [56] is compressed compared to the compressed portion [52] shown in FIG. 5A. As a result, there are more areas of differently-compressed data in the compressed portion [56]. As previously described, the level of compression increases in these areas across the image, so area 56a is least compressed, area 56b is more compressed than area 56a, and so forth through areas 56c, 56d, and 56e.

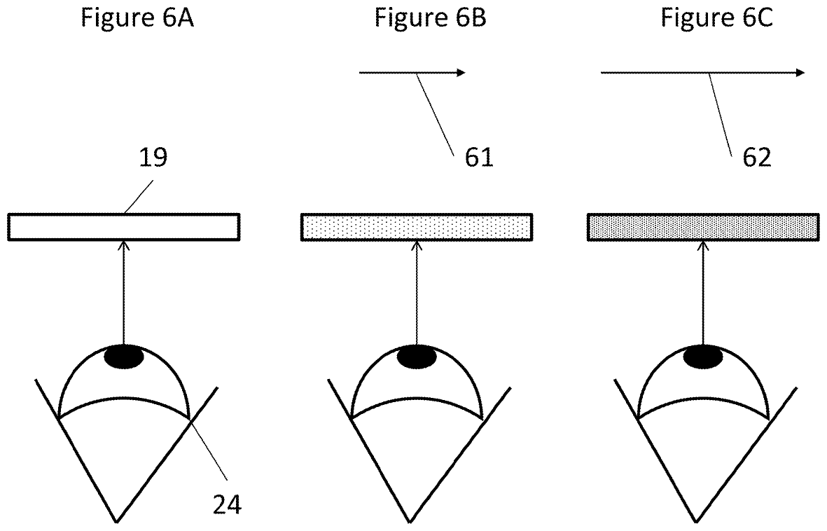

FIG. 6 shows staged compression. This relies on the fact that when a user [23] moves his or her head, he or she will not fully process visual detail while the movement continues, resulting in lower conscious acuity. The faster the movement, the less detail will be consciously visible: the user's vision will become ‘blurred’. In this example, the methods of the invention are triggered by a linear movement, but the same effect could take place when the headset [12] moves in an arc as previously described.

In FIG. 6A, the headset [12] is not moving, and a low level of compression (or no compression) is applied so that the detail of the image shown on the display panel [19] is unchanged.

In FIG. 6B, the arrow [61] shows that the headset [12] is moving to the right. However, the relatively short length of the arrow [61] shows that the rate of movement is low. Nevertheless, since the image data is changing by a speed comparable to the movement, it will be apparent that there will be some loss of acuity. As a result, compression can be applied to the whole image such that some detail may be lost, as shown by the dotted hatching of the display panel [19] shown in the Figure.

In FIG. 6C, the length of the arrow [62] shows that the headset [12] is moving to the right at a high speed. This means that a user wearing the headset [12] is moving his or her head quickly and will have low acuity, so a high level of compression, resulting in loss of information, may be applied to the whole image, as shown by the dark hatching of the display panel [19] shown in the Figure, without the user perceiving the loss of clarity.

FIG. 6 shows three gradations of the level of compression, but there may be any plural number of gradations, such that the system may be a binary determination that if there is motion staged compression is applied and not otherwise, or there may be many levels of compression, each reducing the volume of data and sacrificing detail to a greater extent than the last.

As indicated by the fact that in the Figure the eye [24] is always shown gazing directly ahead, shown by the position of the pupil and the direction of the arrow connecting the eye [24] to the display panel [19], the actual direction of the user's [23] gaze is immaterial when this method is in use; the same level of compression is applied across the image.

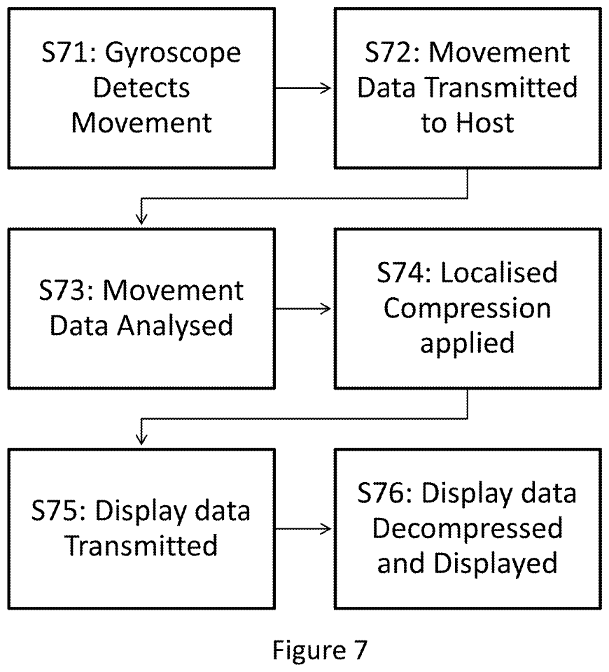

FIG. 7 shows the process in use in FIG. 3, for localised relative compression. It will be described with reference to the example shown in FIG. 3B. A similar process may be used for the versions of localised relative compression shown in FIGS. 4 and 5, and variations will be described where appropriate.

At Step S71 the gyroscope [22] detects a rotational movement of the headset [12] to the right. If the headset [12] is in use, this will indicate that the user [23] is turning his or her head and therefore is likely to be looking in the direction of movement, as described above with reference to FIG. 3. Data indicating that the headset [12] is rotating to the right is transmitted to the host [11] at Step S72.

As described in FIG. 1, the sensor data is received by both the processor [13] running the application and the compression engine [14] on the host [11]. The processor [13] analyses the sensor data and uses it in the generation of the next frames of display data, based on the movement. It transmits a finished frame to the compression engine [14].

The compression engine [14] receives the sensor data and analyses it at Step S73 to determine the direction of motion. Alternatively, this function may be carried out by a dedicated analysis engine, and analysis may take place before the generation of new display data, rather than both the application and the compression engine [14] performing their own analysis. Furthermore, the application could receive the sensor data and use it to generate instructions or derived data for the compression engine [14], containing information on the direction of movement and potentially predictions of future movements. In any case, the compression engine [14] determines the direction of movement.

In this example, the sensor data is produced by a gyroscope [22] which detects rotational movements. In other embodiments in which a less-specialised sensor or combination of sensors [110] is used, such as analysis of images from an external camera, the host [11] may also have to determine whether the movement is rotational—i.e. in an arc—or some other form of movement. This process might then only continue if the direction of movement is on an arc, i.e. corresponding to a user's head turning.

In the embodiment shown in FIG. 4, the speed of movement will also be required. This may be determined from the gyroscope [22] if the gyroscope provides speed as well as rotation data, or it may be determined from other sensors [110] such as an accelerometer [21], camera, etc. as previously mentioned. This information may also be determined by the compression engine [14] or by a dedicated analysis engine.

As previously mentioned, the speed of movement may be used in either of the embodiments shown in FIG. 3 to determine whether compression should be used, and may be used in the embodiment shown in FIG. 5 to determine the amount of the image to be compressed, as in FIG. 4.

In some embodiments, the output from sensors [110] on the headset [12] may be analysed in a processor on the headset [12] to determine speed and direction of movement. This processed data is then transmitted to the host for use in generation and compression of display data.

At Step S74, localised relative compression is applied to compress the display data forming a trailing portion [32] of the image relative to the display data forming the leading portion [33] of the image. This may, for example, involve exercising two compression algorithms such that in each row of pixels received from the application, the first third—comprising the left-hand side [32] of the image—are compressed with a lossy compression algorithm while the second two thirds—comprising the right-hand side [33] of the image—are compressed with a lossless compression algorithm. Alternatively, the compression engine [14] may receive the frame as tiles with location information or split a received frame into tiles with location information, allowing it to determine location of the tiles in the frame regardless of their order, allowing the left-hand tiles [32] of the image to be compressed with the lossy compression algorithm in parallel to the compression of the right-hand tiles [33] with the lossless compression algorithm.

Naturally, the lossless compression algorithm used for the right-hand side [33] of the image may be replaced with a lossy compression algorithm that nonetheless causes less data loss than the compression algorithm used for the left-hand side [32] of the image or no compression could be used for the right-hand side [33] of the image.

Furthermore, the speed of the movement could also be considered such that compression is not applied unless the movement is above a predetermined speed threshold. This would take into account the possibility that the user [23] is turning his or her head while keeping his or her eyes [24] focussed on a fixed point; this is only possible at slow speeds.

In the variations shown in FIGS. 4 and 5, speed is taken into account when localised compression is applied, as previously described. This means that the speed is also determined at Step S73 and compared to one or more thresholds. Each threshold is associated with a proportion of the image to be compressed and where, in the example described above with reference to FIG. 3, one-third of the image is compressed, this amount is replaced by the proportion corresponding to the speed of the movement. In this case, the leading portion [43/47/52/56] and trailing portion [42/46/53/57] may each be any size smaller than the whole image and may change in size on a frame-to-frame basis.

In any case, at Step S75 the compressed display data is sent to the output engine [15] and thence transmitted to the headset [12] to be received by the input engine [17]. Then, at Step S76, it is sent to the decompression engine [18], decompressed as appropriate, and displayed on the display panels [19].

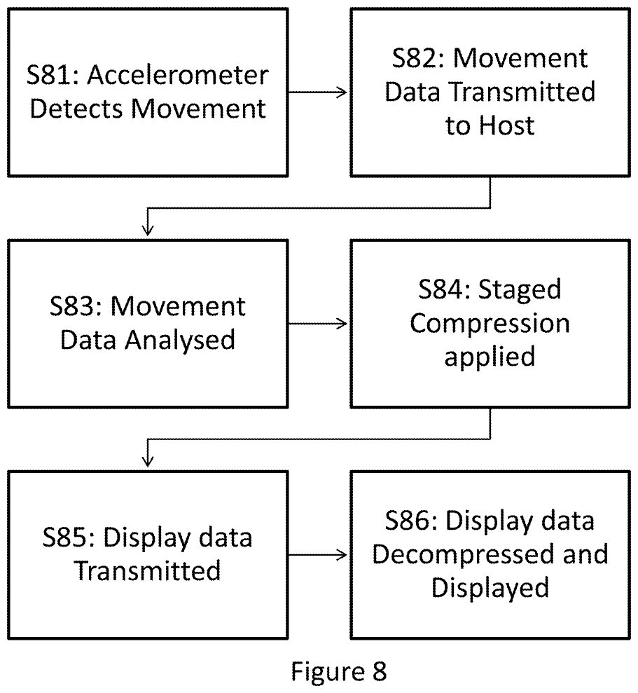

FIG. 8 shows the process applied in FIG. 6, where staged compression is used. It will be described with reference to FIG. 6B.

At Step S81, the accelerometer [21] detects a movement [61] of the headset [12], in this example a movement to the right. It transmits data indicating this movement to the host [11] at Step S82.

As previously described, this data is used both for the generation of new display data and—according to this embodiment of the invention—to control compression. As such, the movement data is analysed at Step S83 to determine the speed of the movement [61] in a similar way to the movement data described in FIG. 6. For the purposes of staged compression, the direction is immaterial, though of course more detail will be required for the generation of the display data. The speed of the movement [61] is supplied to the compression engine [14].

In some embodiments, analysis to determine the speed of the movement may be carried out in a processor on the headset [12] and the determined speed transmitted to the host [12] for use in controlling compression.

In this example, the sensor data is produced by an accelerometer [21] which may not distinguish between straight and rotational movements. In other embodiments in which a less-specialised sensor or combination of sensors is used, such as analysis of images from an external camera, the host [12] may also have to determine whether the movement is rotational—i.e. in an arc—or some other form of movement. It may then amend the application of compression depending on the type of movement.

At Step S84, staged compression is applied. In FIG. 6B, the movement [61] is relatively slow, so a low level of compression is applied. This may be a binary determination, such that if the speed of the movement [61] is above a minimum threshold lossy compression is applied, but otherwise no compression or lossless compression is applied. Alternatively, there may be multiple levels of compression as shown between FIG. 6B and FIG. 6C, such that fast movement triggers the application of a high level of compression and slower movement triggers a lower level of compression. Depending on the algorithm, this may be a smooth continuum or thresholds may be used for different levels of compression.

In any case, at Step S85 the compressed display data is transmitted to the headset [12] at Step S85 and then decompressed and displayed at Step S86.

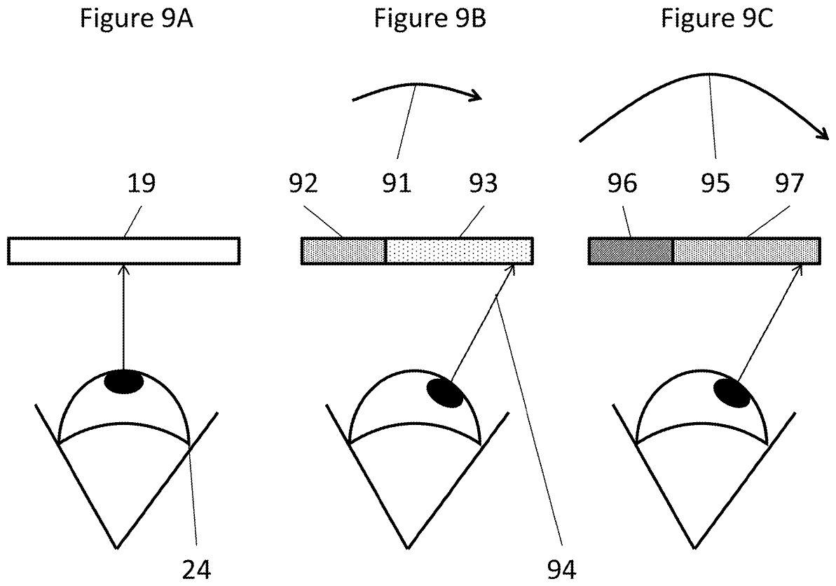

FIG. 9 shows adaptive compression, which is a hybrid of localised and staged compression, incorporating aspects of both to maximise the compression applied and minimise the volume of data transmitted.

FIG. 9A shows the case where the headset [12] is not in motion and the user [23] is assumed to be looking at the centre of the image, as described in FIG. 3A. In this case, a base level of compression is applied.

FIG. 9B shows the case where the headset [12] is moving as the user [23] turns his or her head to the right. The relatively short length of the curved arrow [91] shows that the rate of movement is low, as previously described in FIG. 6B. Unlike the staged compression described in FIG. 6, however, the assumed direction of the user's gaze [94] is taken into account: he or she is assumed to be looking in the direction of movement [91], as described in FIG. 3B, and therefore localised compression is also applied to an area on the left of the image [92]. This results in an area [92] which is at a higher compression level than the rest of the image [93], shown by the darker hatching.

FIG. 9C shows the case where the headset is moving at a faster rate, as shown by the length of the curved arrow [95]. As in FIG. 9B, the user is now assumed to be looking in the direction of movement, so both types of compression are applied: staged compression is used on the entire image [97], as shown by the hatching, which is darker than that used in FIG. 9B as a higher level of compression is used to reflect the faster movement. Meanwhile, localised compression is also used on the left-hand side of the image [96], as shown by the fact that the hatching in this area is darker still.

This combination is especially useful because the user is in fact more likely to be looking in the direction of movement where the movement is fast; small and slow rotations of the head may be carried out with the eye fixed on a point, but this is unlikely to occur with fast movements.

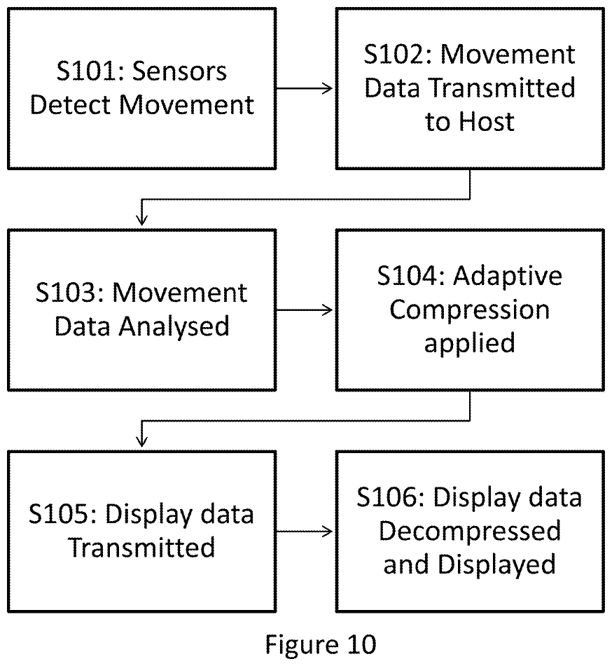

FIG. 10 shows the process associated with the adaptive compression shown in FIG. 9. It will be described with reference to FIG. 9B.

At Step S101, the sensors [110] detect movement of the headset [12]. As previously described, the gyroscope [22] detects rotation and its direction while the accelerometer [21] detects the speed of the movement, and in this case both will be used for adaptive compression. The sensor data is transmitted to the host [11] and received by the compression engine [14] and application [13] as previously described at Step S102.

At Step S103, the compression engine [14]—or a connected analysis engine—analyses the received sensor data to determine the type, direction, and speed of the movement. It then applies adaptive compression at Step S104. As described in FIG. 9, this means applying lossy compression across the trailing left-hand part of the frame [92] at a relatively high level and across the rest of the frame at a lower level [93].

As previously mentioned, different types of compression might be applied depending on the type of movement. For example, if at Step S103 the compression engine [14] or analysis engine determines that the movement is linear with no rotational component, the localised compression component of adaptive compression might be omitted and the process continue as described in FIG. 8.

Thresholds could be used as appropriate. For example, there might be no compression or a low level of compression applied until the speed of the movement is above a minimum threshold, then only staged compression as described in FIG. 6 could be used until the movement [91, 95] is above a second threshold, to take account of the fact that the user [23] may continue to look at a fixed point regardless of head movements if the movement is slow.

In any case, at Step S105 the compressed data is sent to the output engine [15] for transmission to the headset [12], where it is decompressed and displayed on the display panels [19] as appropriate at Step S106.

Due to the format of the Figures, all examples have been described in terms of side-to-side movement in two dimensions. This does not limit the range of movement to which the methods of the invention may be applied; changes in the compression area and level as herein described could also be applied to a trailing edge in vertical movement, or part of each of two trailing edges in diagonal movement, as appropriate.

Although only one particular embodiment has been described in detail above, it will be appreciated that various changes, modifications and improvements can be made by a person skilled in the art without departing from the scope of the present invention as defined in the claims. For example, hardware aspects may be implemented as software where appropriate and vice versa. Furthermore, the variations on localised relative compression described above with reference to FIGS. 4 and 5 could also be used in a system such as that described with reference to FIGS. 9 and 10. Furthermore, it will be appreciated that the shape of the frame portions/regions need not be rectangular. Their shape can be arbitrary, and can for example be radial to accommodate the shape of human visual acuity or a straight line across the image or adapted around the nature of the compression algorithm (e.g. be tile based, if the compression algorithm operates on tiles into which an image may be divided).

1. A method at a host device for compressing display data forming an image for display on one or more displays of a wearable headset, the method comprising:
receiving from the wearable headset, information regarding a direction of movement of the wearable headset, including the one or more displays, the direction being between a trailing position and a leading position;
if the direction of the movement is on an arc, compressing the display data forming a trailing portion of the image relative to the display data forming a leading portion of the image, when displayed on the one or more displays that are moving with the wearable headset, wherein the leading portion and the trailing portion may be of any size smaller than the whole image and may change in size on a frame to frame basis; and
forwarding the display data forming the image from the host device to the wearable headset for display on the one or more displays thereof.

2. The method of claim 1, wherein the information further comprises a speed of the movement and compression of the display data forming at least the trailing portion of the image is performed if a speed of the movement is above a minimum threshold.

3. (canceled)

4. The method of claim 2, wherein the compression of the display data forming a part of, or the whole of the image is based on the speed of the movement above a minimum threshold.

5. The method of claim 4, wherein the compression of the display data forming a part of, or the whole of the image is increased as the speed of the movement above the minimum threshold increases.

6. A method at a host device for compressing display data forming an image for display on one or more displays of a wearable headset, the method comprising:
receiving from the wearable headset information regarding a speed of movement of the wearable headset, including the one or more displays;
if the speed of the movement is above a minimum threshold, compressing the display data by an amount based on the speed of the movement above the minimum threshold; and
forwarding the compressed display data from the host device to the wearable headset for display thereon.

7. The method of claim 6, wherein the compression of the display data forming the image is increased as the speed of the movement above the minimum threshold increases.

8. The method of claim 6, wherein the information further comprises a direction of movement of the wearable headset, including the one or more displays, the direction being between a trailing position and a leading position, the method further comprises, if the direction of the movement is on an arc, compressing the display data forming a trailing portion of the image relative to the display data forming a leading portion of the image, when displayed on the one or more displays that are moving with the wearable headset.

9. The method of claim 1, wherein the display data forming a trailing portion of the image is compressed by a higher compression factor than the display data forming a leading portion of the image.

10. The method of claim 9, wherein compression of the display data is increased in portions across the image in the direction from the leading portion to the trailing portion of the image.

11. The method of claim 2, wherein the trailing portion increases in size compared to the leading portion of the image as the speed of the movement above the minimum threshold increases.

12. The method of claim 2, further comprising, at the host device:
determining, from the information, whether the movement is on an arc or linear;
determining, from the information, the speed of the movement of the wearable headset; and
determining whether the speed of the movement is above the minimum threshold.

13. (canceled)

14. A method at a wearable headset for displaying display data forming an image on one or more displays, the method comprising:
sensing movement of the wearable headset indicative of movement of the one or more displays;
determining whether the movement is on an arc or linear;
determining the speed of the movement of the wearable headset;
determining whether the speed of the movement is above a minimum threshold;
sending information regarding the speed and direction of the movement to a host device, if the movement is on an arc and the speed is above the minimum threshold;
receiving from the host device, the display data forming the image; and
displaying the image on one or more displays.

15. The method of claim 14, wherein the sensing movement of the wearable headset comprises using a gyroscope and an accelerometer in the wearable headset.

16. A host device comprising:
a non-transitory memory storing (instructions or local data); and
one or more hardware processors coupled to the non-transitory memory and configured to execute the instructions from the non-transitory memory to cause the host device to perform operations comprising:
receiving from the wearable headset, information regarding a direction of movement of the wearable headset, including the one or more displays, the direction being between a trailing position and a leading position;
if the direction of the movement is on an arc, compressing the display data forming a trailing portion of the image relative to the display data forming a leading portion of the image, when displayed on the one or more displays that are moving with the wearable headset, wherein the leading portion and the trailing portion may be of any size smaller than the whole image and may change in size on a frame to frame basis; and
forwarding the display data forming the image from the host device to the wearable headset for display on the one or more displays thereof.

17. A wearable headset comprising:
a non-transitory memory storing (instructions or local data); and
one or more hardware processors coupled to the non-transitory memory and configured to execute the instructions from the non-transitory memory to cause the host device to perform operations comprising:
sensing movement of the wearable headset indicative of movement of the one or more displays;
determining whether the movement is on an arc or linear;
determining the speed of the movement of the wearable headset;
determining whether the speed of the movement is above a minimum threshold;
sending information regarding the speed and direction of the movement to a host device, if the movement is on an arc and the speed is above the minimum threshold;
receiving from the host device, the display data forming the image; and
displaying the image on one or more displays.

18. The wearable headset of claim 17, wherein the wearable headset comprises one of: a virtual reality headset, and an augmented reality set of glasses.

19. (canceled)

20. A system comprising a host device according to claim 16 and a wearable headset connected to the host device.

21. A host device comprising:
a non-transitory memory storing (instructions or local data); and
one or more hardware processors coupled to the non-transitory memory and configured to execute the instructions from the non-transitory memory to cause the host device to perform operations comprising:
receiving from the wearable headset information regarding a speed of movement of the wearable headset, including the one or more displays;
if the speed of the movement is above a minimum threshold, compressing the display data by an amount based on the speed of the movement above the minimum threshold; and
forwarding the compressed display data from the host device to the wearable headset for display thereon.

22. A system comprising a host device according to claim 21 and a wearable headset connected to the host device.

23. The method of claim 8, wherein the display data forming a trailing portion of the image is compressed by a higher compression factor than the display data forming a leading portion of the image.

24. The method of claim 23, wherein compression of the display data is increased in portions across the image in the direction from the leading portion to the trailing portion of the image.

25. The method of claim 8, wherein the trailing portion increases in size compared to the leading portion of the image as the speed of the movement above the minimum threshold increases.

26. The method of claim 8, further comprising, at the host device:
determining, from the information, whether the movement is on an arc or linear;
determining, from the information, the speed of the movement of the wearable headset; and
determining whether the speed of the movement is above the minimum threshold.
